(19) United States
(12) Patent Application Publication
(10) Pub. No.: US 2012/0152127 A1
(43) Pub. Date: Jun. 21, 2012

(54) COOKING SYSTEM AND APPARATUS

(75) Inventor: Chris Tsioukis, Preston, VIC (AU)

(73) Assignee: VICTORIA SNACK FOOD CORPORATION PTY. LTD., Preston, VIC (AU)

(21) Appl. No.: 13/379,941

(22) PCT Filed: Jun. 24, 2010
(86) PCT No.: PCT/AU2010/000798

§ 371 Date: Mar. 2, 2012

(30) Foreign Application Priority Data
Jun. 24, 2009 (AU) 2009902937

(51) Int. Cl. A47J 37/04

(52) U.S. Cl. 99/341; 99/419

(57) ABSTRACT

Cooking apparatus having plurality of skewer holders (31) holding a plurality of skewers (45) in a vertical planar arrangement by hinged mount (60) in a hinged manner relative to the planar arrangement of the array of cooking elements (25). The hinged mounting of the plurality of skewer holders (31) allows for the plurality of skewers (45) to be moved from a position extending in a narrowly spaced planar arrangement to the planar arrangement of the array of cooking elements (25) or be moved to a non cooking further spaced position.

### FIELD OF THE INVENTION

The present invention relates to a cooking system, and more particularly to a system of cooking prepared food in a commercial setting. It provides a cooking apparatus for use in cooking food on skewers.

### Background to the Invention

The prior art has provided for the use of skewers to be used in the skewing of raw meat and vegetables for placement over a source of heat. The use of a skewer is usually in combination with a rotating means such that the heat from one direction cooks the food evenly around the circumference of the rotating skewered food.

Traditionally such skewers are either heavy metal structures, which are cumbersome or heat quickly posing a risk to a user who inadvertently handles the metal skewer, or thin wooden structures which must be soaked in water for several hours to avoid drying or burning out. Where the skewers are to be exposed to an open flame, the wooden structures are likely to burn through and disintegrate, dropping the meat they are to hold and leaving an undesired taste or splinters in the meat.

The direct source of heat such as a flame is a common feature of many apparatuses used in the cooking of meat on skewers. Utilising an open flame for cooking is disadvantageous as it is firstly difficult to reach the desired temperature, secondly, it is difficult to maintain a consistent temperature to ensure that all the meat on the skewers are cooked evenly and thirdly it is difficult to ensure that the heat source is distributed evenly on the meat.

Further, the cooking of skewers in the residential arena may require the use of a grill. The disadvantage is that the user must individually rotate the skewers to ensure the meat is adequately cooked in addition to constantly having to take the skewer out of the heating compartment to view and taste. This disruption in the cooking process will affect the taste and texture of the meat.

These disadvantages are greatly amplified in the commercial arena.

It is well known that the consumption of meat which has been inadequately cooked may lead to food poisoning. It is therefore imperative that where an individual is expected to cook large quantities of meat rotisserie style that the meat is cooked at the correct temperature for the appropriate duration.

Currently, the prior art fails to achieve these objectives. In one form, the prior art illustrates the use of a vertical metal skewer which rotates around a heat element. The meat cooks slowly in an open environment with a single heating element. In such a system, the meat is not cooked evenly and may result in a consumer consuming meat which is under and/or over cooked. This is a significant health risk in the food industry. A further health risk is where the meat, when cooked in an open environment, is susceptible to germs and bacteria.

In addition, such open environment systems are unable to achieve and maintain the desired temperature and merely act as a heating device rather than a cooking device.

Where the prior art provides for the cooking of skewered meat in an enclosed element, there is no feature implemented to be able to view the skewered meat as it proceeds through the cooking process. As a result, it is difficult to determine when the meat has been cooked and so the user must constantly open the door to the system to view the meat. This results in a loss of heat. The enclosed system must then take time to reheat to the required temperature which effectively extends the cooking process and requires further energy or electricity to operate. In addition, the disruption in the cooking process will affect the taste and texture of the meat.

A further disadvantage of the current enclosed cooking system in the commercial arena is that the user is required to remove each individual skewer one at a time. As each separate skewer must be separately removed, it is an inefficient and ineffective system in a commercial setting. Further, the increase in handling by an individual raises the risks of spread of germs and bacteria if not handled appropriately. In addition, it illustrates a potential risk to employees from the heat emanating from the skewers.

Further, an employee must individually coat the skewers with the require sauce or marinade. This is time consuming and tedious and requires for the door of the enclosed cooking system to be opened during the cooking process. It can also pose risks where the employee attempts to coat the skewers without removing them from the enclosed cooking system. If removing the skewers from the enclosed cooking system, the meat will cool down interrupting the cooking process.

It is an object of the present invention to provide an improved cooking system which overcomes or at least ameliorates one or more of the problems of the prior art.

### SUMMARY OF THE INVENTION

According to one aspect, the present invention provides a cooking system for and including: receiving and holding a plurality of skewers holding uncooked food in a skewered arrangement wherein the plurality of skewers are substantially vertically aligned; providing a skewered-food cooker for cooking the plurality of skewers in the substantially vertically aligned arrangement; and providing an overflow receptacle below the substantially vertically aligned arrangement of skewers; whereby the plurality of skewers in substantially vertically aligned arrangement provide cooking of the food and dripping of expelled cooking juices to a lower skewer and to the overflow receptacle.

Preferably the arrangement allows for ready viewing of the substantially vertically aligned arrangement of skewers of food while cooking.

Also preferably the cooking system can include an after cooking sauce flavouring system which allows a single cooking process to provide a plurality of different final products as if cooked in different manners.

The invention also provides a skewered-food cooker including: an array of cooking elements and a plurality of skewer holders arranged in relative position to the array of cooking elements and for receiving and holding an end portion of the skewers in close proximity to the array of cooking elements to allow uncooked food thereon to be cooked.

The skewered-food cooker can have the array of cooking elements in a planar arrangement and the plurality of skewer holders allowing a plurality of skewers with uncooked food thereon to extend in a narrowly spaced planar arrangement.

The plurality of skewers with uncooked food thereon can extend in a vertical planar arrangement such that juices from one skewer will fall and baste the skewer below.

An overflow tray can be located below the vertical planar arrangement of the plurality of skewers to collect excess drippings.

The plurality of skewers in a vertical planar arrangement can be mounted in a hinged manner relative to the planar arrangement of the skewer cooking elements such that the plurality of skewers with food thereon can be moved from a position extending in a narrowly spaced planar arrangement to the planar arrangement of the skewer cooking elements or be moved to a non cooking further spaced position.

The skewered-food cooker can have a front panel that overlies the planar arrangement of the plurality of skewers. The front panel can be formed of a transparent material to allow ready viewing of the plurality of skewers in a planar arrangement. The front panel can be heat reflective so as to reflect heat back towards the food on the skewers.

In one form the front panel of the skewered-food cooker can be mounted in a hinged manner relative to the planar arrangement of the skewer cooking elements such that the front panel of the skewer cooking element can be moved from a position extending in a narrowly spaced planar arrangement to the planar arrangement of the skewer cooking elements or be moved to an open position allowing access to food on the skewers mounted in the planar arrangement.

Each skewer can have a flat finger holding plate at one end of the skewer shaft to facilitate handling and to provide an advertising location.

Each skewer holder can include a mounting element having a trumpet opening for receiving the end of a skewer and directing it to a central opening having a circumferential frictional gripping element. The gripping element can be a silicon ring. The skewer holder can include a detachment means allowing ready access from the rear of the trumpet and replacement of the circumferential frictional gripping element.

The present invention provides for an improved cooking system which overcomes or at least ameliorates one or more of the problems of the prior art by providing for a cooking system that is effective, convenient and cost efficient to operate.

### BRIEF DESCRIPTION OF THE DRAWINGS

Preferred embodiments of the invention will now be described, by way of example only, with reference to the accompanying drawings, in which:

FIG. 1 is a diagrammatic perspective front view of a skewered-food cooker in accordance with an embodiment of the invention;

FIG. 2 is a diagrammatic perspective front view of the skewered-food cooker of FIG. 1 with open front;

FIG. 3 is diagrammatic perspective front view of a skewered-food cooker of FIG. 1 with heating elements not shown but skewer holders maintaining skewers in cooking position;

FIG. 4 is diagrammatic perspective front view of a skewered-food cooker of FIG. 1 with heating elements and skewers not shown but skewer holders rotated to a access position for insertion or removal of skewers;

FIG. 5 is diagrammatic cross sectional view of a skewer holder of the skewered-food cooker of FIG. 1;

FIG. 6 is diagrammatic plan view of a skewer for holding food for cooking in the skewered-food cooker of FIG. 1;

FIG. 7 is a diagrammatic plan view if a skewered-food cooker in accordance with a second embodiment of the invention;

FIG. 8 is a diagrammatic top view of the skewered-food cooker of FIG. 7 with open front;

FIG. 9 is a diagrammatic cross sectional view of a skewered holder of the skewered-food cooker of FIG. 7; and

FIG. 10 is a diagrammatic plan view of a skewered-food cooker of FIG. 7 with heating elements not shown but skewer holders maintaining skewered in cooking position.

### DESCRIPTION OF PREFERRED EMBODIMENTS OF THE INVENTION

Referring to the drawings there are shown two embodiments. Same numbers are allocated to similar features of each embodiment.

The cooking system and apparatus makes use of a skewered-food cooker having an array of cooking elements 25 and a plurality of skewer holders 31 arranged in relative adjacent planar position to the array of cooking elements and for receiving and holding an end portion of the plurality of skewers 45 in close proximity to the array of cooking elements to allow uncooked food thereon to be cooked.

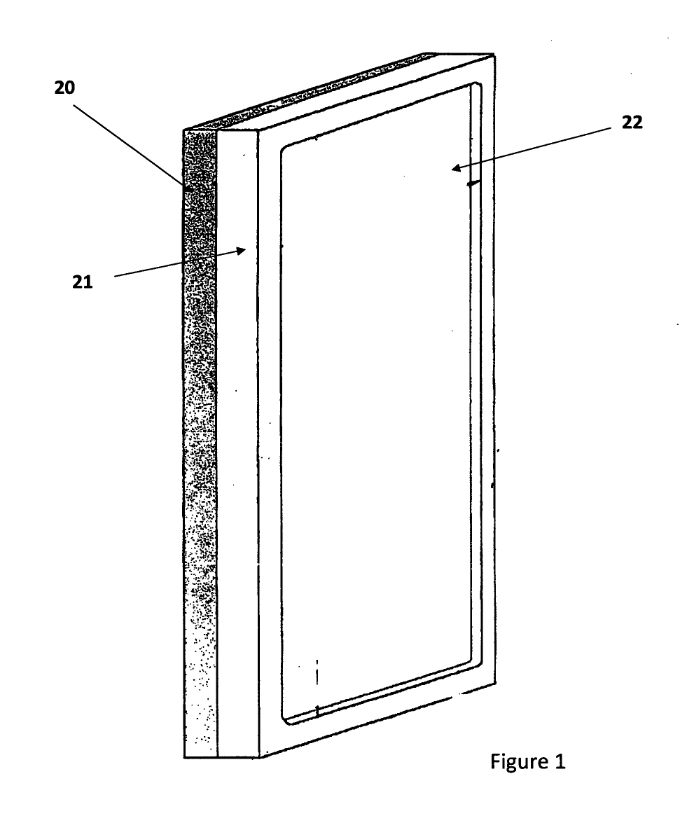

As shown in FIG. 1 the skewered-food cooker has a vertical cooking base 20 and a front panel 21 that overlies the planar arrangement of the plurality of skewers 45. The front panel 21 can be formed of or include a window 22 of a transparent material to allow ready viewing of the plurality of skewers in a planar arrangement. Such a feature allows for a user to view the plurality of skewers 45 during the cooking process to ensure the uncooked food is cooked for an appropriate period of time at the optimum temperature. The front panel is heat reflective so as to reflect heat back towards the food on the skewers. In one embodiment the front panel can be formed of heat reflective glass.

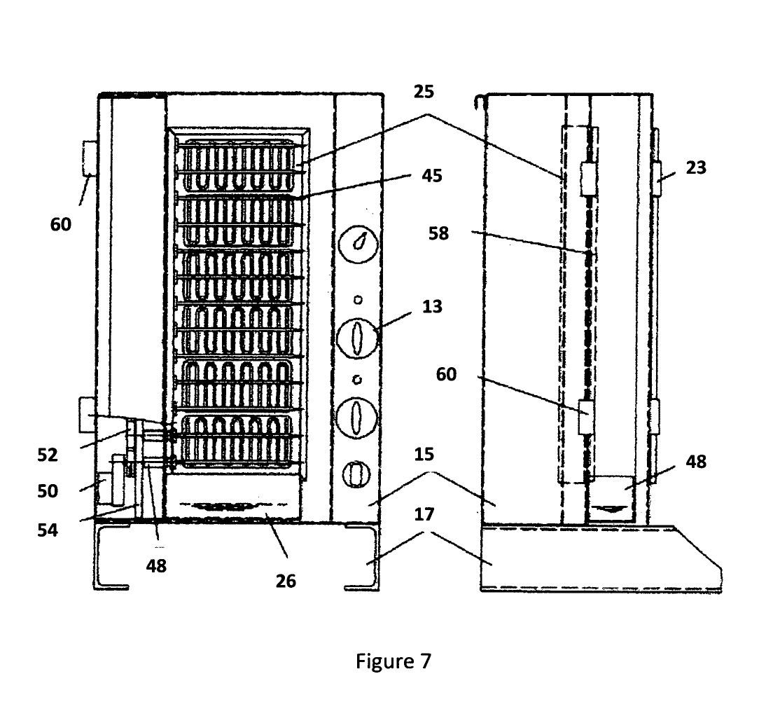

In the embodiment illustrated in FIG. 7, the skewered-food cooker is further provided with an outer panel 15 which can comprise of temperature controls 13 to assist a user in reaching and maintaining the desired cooking temperature. The temperature controls 13 are positioned on the outer panel 15 independent of the front panel 21. However, the temperature controls can also be manufactured on the front panel 21.

The temperature controls are knobs or buttons for increasing or decreasing the temperature as desired. The temperature controls can also include a screen in order to indentify to the user the current temperature and additional settings, such as the use of fans or whether the overflow tray 26 is full. Other such controls can include timer and alarm functions to alert the user to check the cooking process when a predetermined period of time has passed.

The vertical cooking base 20 of the skewered-food cooker can further be supported on a horizontal base 17 as illustrated in FIG. 7. The horizontal base may be insulated and/or vented in order to assist in maintaining an appropriate ambient temperature around the food cooker for the duration of the cooking process.

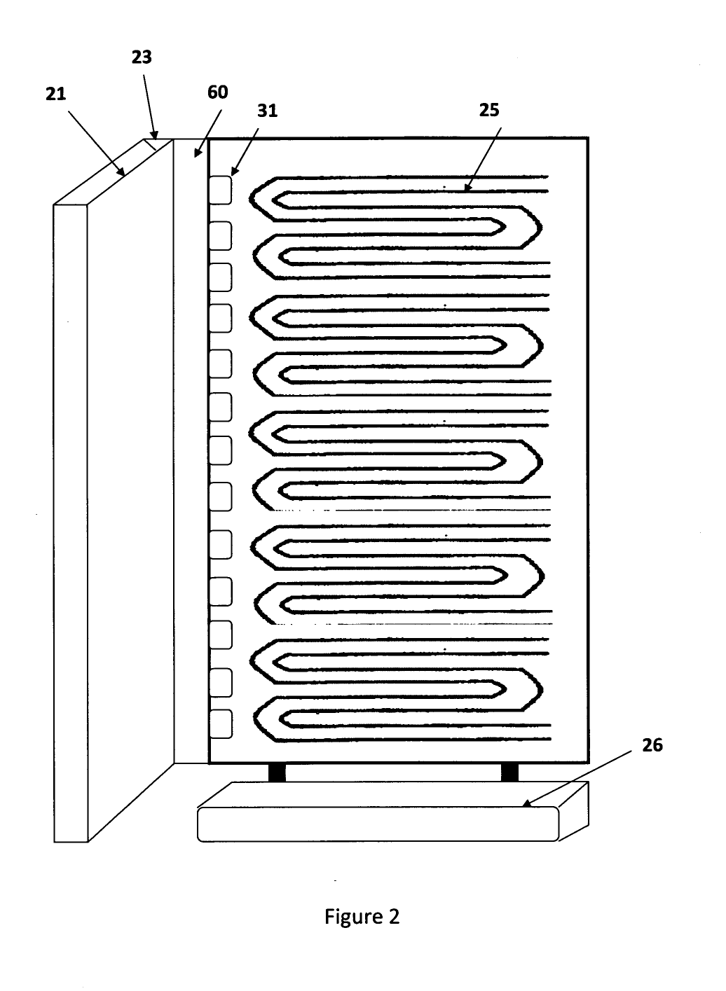

The array of cooking elements 25 are arranged in a planar arrangement. The cooking elements can have two intertwining resistance heat dissipating linear tracks of 1000 Watts and 1500 Watts that can be used independently or together to provide variation in cooking. FIGS. 2 and 7 provide two examples of the arrangement of the array of cooking elements 25 however, it is envisaged that different arrangements can be incorporated as desired or appropriate for the use.

The plurality of skewer holders 31 are arranged in relative adjacent planar position to the array of cooking elements 25 so that the plurality of skewers 45 holding the uncooked food in a skewered arrangement are held in such a manner that they are in a close proximity to the array of cooking elements 25 to allow the uncooked food to be cooked. The close proximity to the array of cooking elements 25 is defined by the defining compartment 58. The array of cooking elements 25 will provide for such heat to cook the uncooked food. The array of cooking elements 25 are temperature controlled allowing the user, through the use of the temperature controls 13, to monitor and alter the temperature of the array of cooking elements for the duration of the cooking process.

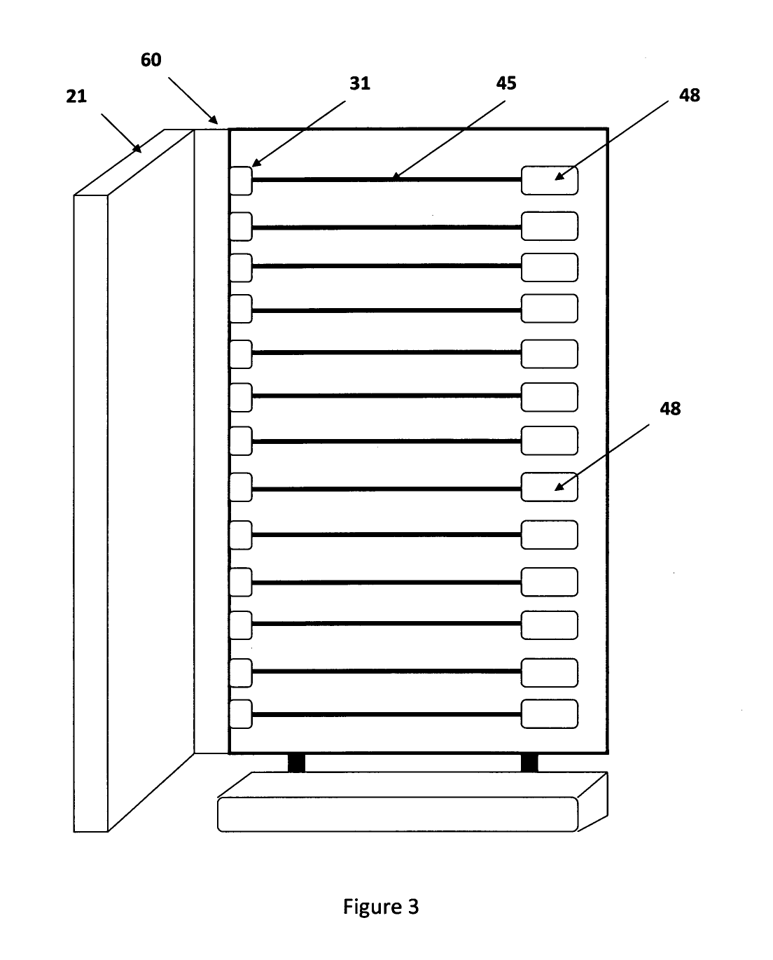

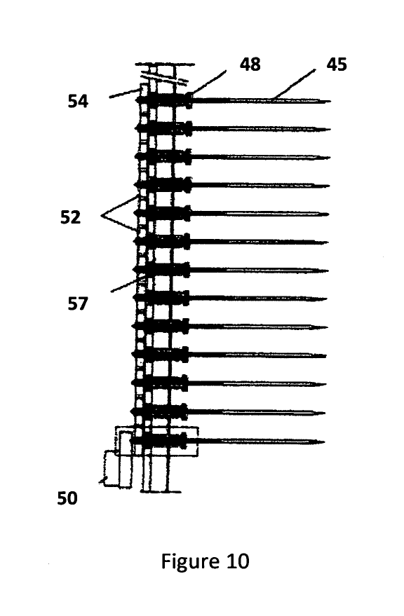

The plurality of skewers 45 holding the uncooked food in a skewered arrangement are arranged within the skewered-food cooker in a vertical planar arrangement, as seen in FIGS. 3 and 10, such that the juices dripping from the skewer above will fall onto and baste the plurality of skewers 45 below. In such a manner, the user is not required to continually open the skewered-food cooker to flavour the food on the skewers. In addition, as the food is continually marinaded gradually over the course of the cooking process, it enhances the taste and flavour of the food.

In a further embodiment, the plurality of skewers 45 are arranged in a plurality of columns within the skewered-food cooker increasing the quantity of food which can be cooked. To further increase the quantity of food to be cooked, the plurality of skewer holders 31 can be arranged in a complementary fashion along two sides of the skewered-food cooker so that each second arranged skewer is positioned in a handle portion to skewer tip manner. In a further embodiment, the skewered-food cooker may provide for more than one hinged mount allowing a layered or offset effect. As the cooking system allows for the juices dripping from one skewer to fall and baste the skewers below, a further embodiment may provide for a motorised hinged mount allowing rotational movement of the skewers so that a skewer does not remain in the topmost position. This will ensure that the plurality of skewers 45 are evenly marinaded.

FIGS. 2 and 7 provide further examples of the arrangements of the plurality of skewer holders 31 for holding a plurality of skewers 45 having a skewer tip 47 at one end and a finger holding plate 48 at the other end. In these examples, the plurality of skewer holders are able to house the skewer tip 47 thereby allowing a user, holding the finger holding plate 48 to slide the skewer tip 47 into respective ones of the plurality of skewer holders 31. This allows an arrangement whereby the finger holding plate 48 is accessible to the user only when the front panel 21 is opened. In another embodiment, the finger holding plate 48 is slid into the plurality of skewer holders 31 concurrently. In this manner the finger holding plate 48 is external to the cooking process and has the advantaged of not being heated during the cooking process and allows a user to independently turn individual skewers 45 as desired.

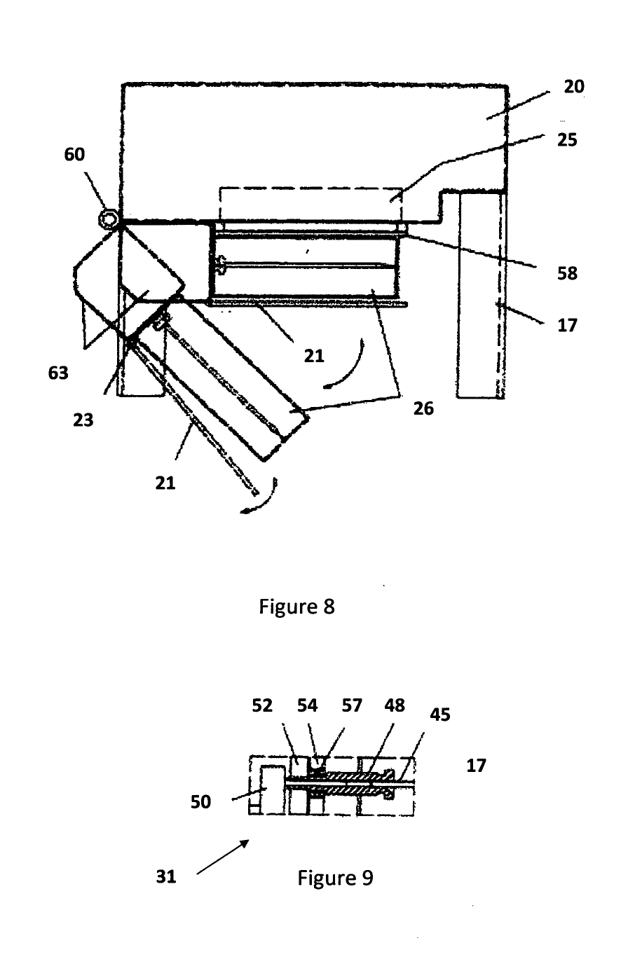

The skewered-food cooker further provides for an overflow receptacle in the form of an overflow tray 26 which is located below the vertical planar arrangement of the plurality of skewers to collect excess drippings from the plurality of skewers. The overflow tray 26 can be removable allowing for the cleaning and replacement of the tray. The overflow tray 26 can be located in a fixed position as seen in FIG. 2. Alternatively, it can be in a movable position as shown in FIG. 8 whereby the opening of the front panel 21 allows the overflow tray 26 to move with the arrangement of the plurality of skewers in order to prevent food drippings and to improve the safe working environment.

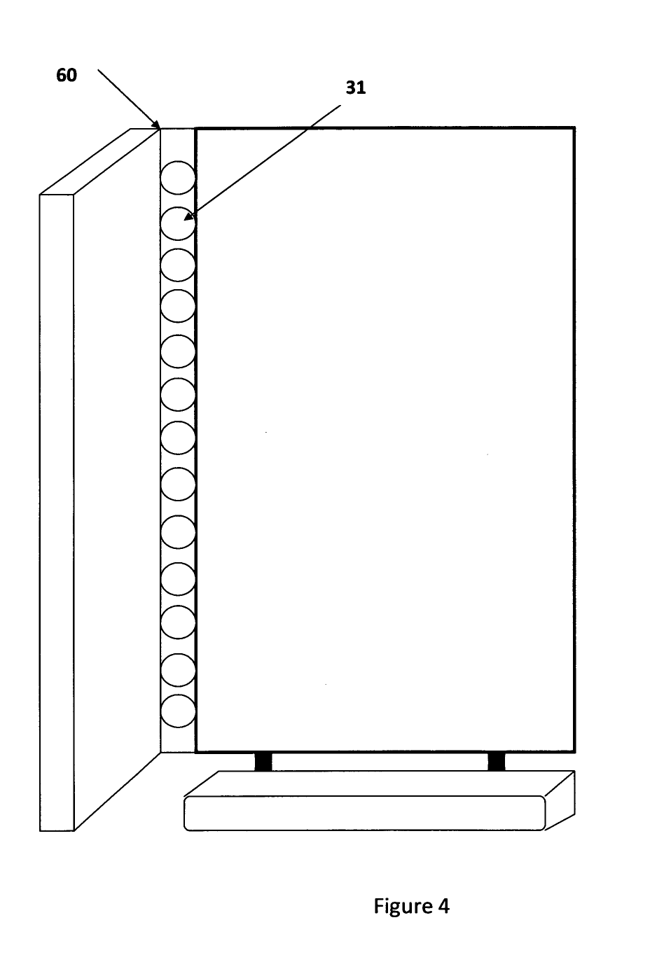

The first embodiment of the dual hinge mechanism is shown in FIGS. 3 and 4, where the plurality of skewer holders 31 holding the plurality of skewers 45 in a vertical planar arrangement can be mounted by hinged mount 60 in a hinged manner relative to the planar arrangement of the array of cooking elements 25. The hinged mounting of the plurality of skewer holders 31 allows for the plurality of skewers 45 to be moved from a position extending in a narrowly spaced planar arrangement to the planar arrangement of the array of cooking elements 25 or be moved to a non cooking further spaced position. Such a feature is advantageous whereby in a commercial setting the plurality of skewers may be constantly replaced between plurality of skewers 45 holding uncooked foods and a plurality of skewers holding cooked foods.

In this embodiment, the front panel 21 is mounted in a hinged manner relative to the planar arrangement of the array of cooking elements 25 whereby the hinged manner comprises of a hinged mechanism 23. Therefore in one embodiment, the front panel 21 of the skewered-food cooker can be mounted in a hinged manner relative to the planar arrangement of the array of cooking elements 25 and allowing the separate hinged movement of the plurality of skewer holders 31 and plurality of skewers 45 mounted therein. In operating a hinged mounting system the front panel 21 can be moved from an open to a closed position allowing access to the plurality of skewers.

Allowing for such ease of access to the plurality of skewers ensures that in a commercial setting the cooking system is efficient and cost effective.

The hinged mechanism 23 can include a lock mechanism in order to limit the extent to which the front panel 21 can open. In addition the hinged mechanism can include a return function whereby the hinged mechanism 23 is biased to a closed position and will automatically return to a closed position if no force is provided and there is no obstruction. The hinged mechanism 23 may also provide for an alarm where the front panel 21 has not returned to its closed position within a set predetermined period to remind the user to close the front panel.

A second embodiment in FIGS. 7 to 10, illustrates an embodiment whereby the hinged mounting system comprises of the hinged mount 60 and the hinge mechanism 23 being attached to a single mount 63.

In this embodiment, the hinged mount 60 provides movement of the front panel 21 and the internal skewered arrangement where the plurality of skewers 45 are substantially vertically aligned. This allows the plurality of skewers 45 to be moved from a position extending in a hinged manner relative to the planar arrangement of the array of cooking elements 25. In such a fashion, the movement of the front panel 21 to an open position provides an open swinging action of the internal skewered arrangement away from the array of cooking element 25.

Further to this embodiment, the hinge mechanism provides movement of the front panel 21 in a manner which is extending from the internal skewered arrangement. This allows the plurality of skewers 45 to be accessed from different sides, or alternatively, by more than one user in a safe and efficient manner. In such an embodiment, as discussed above, the overflow tray 26 can move with the internal skewered arrangement.

In another embodiment, the front panel 21 and the internal skewered arrangement can be joined at the apex by a single hinge mechanism such as the hinged mount 60. In such an embodiment, this may require alterations in the structure of the front panel 21, such as an L-shape structure in contrast to the linear structure shown in FIG. 8.

As shown in FIGS. 7 and 10, the skewered-food cooker provides for a drive means which, in one form, comprises of a motor 50 which is connected to and allows rotation of a rotational rod 52. The rotation of the rotational rod 52 causes rotation of the individual skewers allowing for the heat emanating from the array of cooking elements 25 to be evenly distributed. This occurs as the rotational movement of the rotational rod 52 causes rotation of the skewer holder 31. As the plurality of skewer holders 31 is rotated, the plurality of skewers 45 housed within plurality of skewer holders 31 are rotated.

The motorised movement of the rotational rod 52, causing the rotation of the plurality of skewer holders 31, is dependent on the form of the rotational rod 52. The rotational rod 52 can be in the form of a rod or chain. Where the rotational rod is a chain, it may require two pulleys at opposite vertical ends of the skewered-food cooker. The kinks in the chain, as it is being rotated around the pulleys, will slide frictionally with the front end 32 of the plurality of skewer holders 31 causing the plurality of skewer holders 31 to turn.

In another embodiment, the rotational rod 52 can be a fixed structure with individual ring sections. The front ends 32 of the plurality of skewered holders 31 can be inserted into the ring structures frictionally and, during activation of the circular motion of the ring structures through the use of the motor, cause the rotation of the plurality of skewered holders.

The rotation rod is assisted by the support beam 54. The support beam forms a component of the hinged mount 60 assisting in providing support to the plurality of skewer holders 31 during rotation. It further assists in providing a convenient arrangement of the plurality of skewers 45 to pre-define the area between each of the plurality of skewers 45.

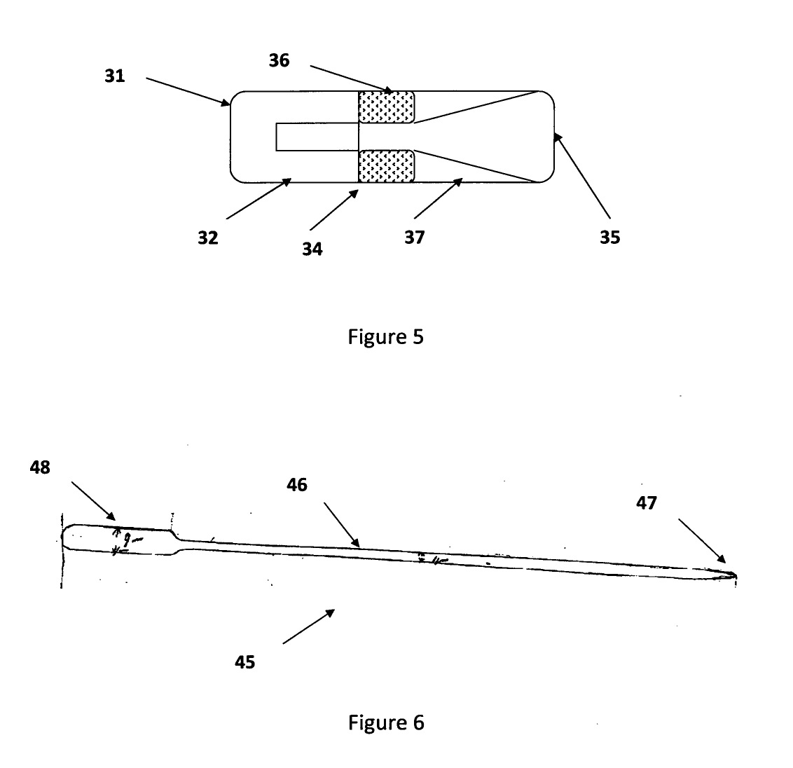

As illustrated in FIG. 5 each of the plurality of skewer holders 31 forms a mounting element for the plurality of skewers 45. In the first embodiment illustrated in FIG. 5, the plurality of skewer holders 31 has a trumpet opening 35 at a front end 32 for receiving the skewer tip 47 and directing it to a central opening having a circumferential frictional gripping element 36. The skewer holder can include a detachment means such as screw thread 34 between front end 32 and rear end 37 of the plurality of skewer holders 31 allowing ready access from the rear of the front end 32 and replacement of the circumferential frictional gripping element 36. In one embodiment the frictional gripping element 36 is a silicon ring. The skewer holder will ensure that the plurality of skewers are held securely in place for the duration of the cooking process.

A second embodiment of the plurality of skewer holders 31 is illustrated in FIG. 9 whereby the skewer holder, instead of a trumpet opening, is provided with a liner opening sufficient in size to allow for the insertion of the plurality of skewers 45. In this second embodiment in FIG. 9, the skewer tip 47 is inserted into the plurality of skewer holder 31. As it is slid into the plurality of skewer holders 31, it is secured by two components. The first component is the frictional fit of the skewer tip 47 as it is pushed and secured to the limit of the plurality of skewer holders 31 and the frictional gripping element 36. The second component is the screw thread 34.

In another embodiment, the plurality of skewer holders 31 can allow for the finger holding plate 48 to be attached by the plurality of skewer holders 31 in a manner which will allow the finger holding plate 48 to be located externally from the array of cooking elements 25.

As shown in FIG. 6, in one aspect of the invention, the cooking system provides for a plurality of skewers 45, however, it is envisaged that the cooking apparatus and system can also be utilised for other cooking functions such as rotisseries. The plurality skewer comprises of three components including a handle portion in the form of a finger holding plate 48, the skewer shaft 46 and the skewer tip 47.

In one embodiment the finger holding plate 48 is rectangular in shape providing for a medium on which to advertise. The advertising can include a business or product name onto the finger holding plate, or, in another embodiment the advertising or decorative pattern can extend down the skewer shaft. In one embodiment, the finger holding plate can be rectangular in shape however, the finger holding plate can be carved into different shapes to become, for example, a finger holding ring if in a circular shape. Further carving of the finger holding plate can allow for shapes such as an outline of a fish or chicken to represent the meat which is placed onto the skewer shaft.

In one embodiment, the skewer shaft 46 is 21.5 cm long. As the skewer shaft 46 acts as the holding means for uncooked food, the length of the skewer shaft 46 allows for a sufficient amount of food, such as raw meat and vegetables, to be held effectively in place. The circumference of the skewer shaft 46 is such that the tip is of corresponding size to the skewer holders allowing for the skewer tip 47 to be placed into the skewer holder for support. The skewer tip 47 will have a point so as to allow raw meats to be skewed onto the skewer shaft.

Although the skewers 45 can be manufactured from a wide variety of materials such as metal, it is preferred that the skewers are made from wood which does no transfer heat to the handle portion of the bar. However, it is envisaged that any other material can be used as desired or appropriate.

The cooking system can include an after cooking sauce flavouring system which allows a single cooking process to provide a plurality of different final products to create the appearance as though the foods have been cooked in different manners.

In a further embodiment of the invention, the skewered-food cooker can be separated into compartments allowing for the array of cooking elements 25 to be adjusted according to each individual compartment such that one compartment may allow for cooking at higher temperatures whilst a separate compartment may allow for heating at a reduced temperature. In addition separate compartments will allow the housing of meats at different stages of the cooking process to ensure no cross contamination.

The current invention further provides for a cooking system including a first step of receiving and holding a plurality of skewers 45 holding uncooked food in a skewered arrangement wherein the plurality of skewers are substantially vertically aligned. The second step requires an array of cooking elements 25 in a relative adjacent planar arrangement for cooking the plurality of skewers 45 in the substantially vertically aligned arrangement. This will allow for the uncooked foods on the plurality of skewers to be cooked. The overflow tray 26 below the substantially vertically aligned arrangement of skewers is to be positioned accordingly to ensure that food substances are not dropped during cooking making it difficult in which to clean the skewered-food cooker. The cooking system therefore allows the plurality of skewers 45 in substantially vertically aligned arrangement to cook food and dripping of expelled cooking juices to a lower skewer and to the overflow receptacle. Those of skill in the art will appreciate that such modifications or changes to the particular embodiments exemplified can be made without departed from the scope of the invention. All such modifications and changes are intended to be included within the scope of the invention.

1. A skewered-food cooker for cooking food mounted on a plurality of skewers including:
i. an array of one or more cooking elements arranged in a predefined arrangement;
ii. a plurality of skewer holders, having a mounting element arranged in a substantially vertical arrangement to hold the plurality of skewers in a vertical and corresponding arrangement in relative position to the array of cooking elements such that the plurality of skewers are visible to the user when cooking; and,
iii. wherein the mounting element of the plurality of skewer holders receiving and holding an end portion of the plurality of skewers with food mounted thereon in substantially close proximity to the predefined and corresponding arrangement of the array of cooking elements to allow uncooked Food thereon to be cooked and the juices from at least one of the plurality of skewers to fall and baste another of the at least one of the plurality of skewers below.

2. A skewered-food cooker according to claim 1 including a drive means for providing rotative effect to each skewer received in a relative skewer holder of the plurality skewer holders and thereby providing an all round cooking effect

3. A skewered-food cooker according to claim 1 wherein the skewered-food cooker has the array of cooking elements in a planar arrangement and the plurality of skewer holders allowing a plurality of skewers with uncooked food thereon to extend in a narrowly spaced adjacent planar arrangement.

4. A skewered-food cooker according to claim 1 including an overflow tray locatable below the substantially vertical planar arrangement of the plurality of skewers to collect excess drippings.

5. A skewered-food cooker according to claim 4 including an overflow tray locatable below and externally to the substantially vertical planar arrangement of the plurality of skewers to collect excess drippings allow removal of the overflow tray without removing the plurality of skewer from the array of one or more cooking elements.

6. A skewered-food cooker according to claim 1 wherein the plurality of skewer holders in a vertical planar arrangement are mounted by hinged connection in a hinged manner relative to the planar arrangement of the array of cooking elements such that the plurality of skewers received therein with food thereon can be moved from a position extending in a narrowly spaced planar arrangement to the planar arrangement of the skewer cooking elements or be moved to a non cooking further spaced position.

7. A skewered-food cooker according to claim 6 including a drive means for providing rotative effect to each skewer received in a relative skewer holder of the plurality of skewer holders being mounted in the hinged connection of the plurality of skewer holders.

8. A skewered-food cooker according to claim 6 including an overflow tray locatable in a hinged manner below the substantially vertical planar arrangement of the plurality of skewers to collect excess drippings whether the plurality of skewers with food thereon are in a position extending in a narrowly spaced planar arrangement to the planar arrangement of the skewer cooking elements or are moved to a non cooking further spaced position.

9. A skewered-food cooker according to claim 3 including a front panel opening and extending substantially along the substantially vertical planar arrangement of the plurality of skewers on the opposite side to the cooking elements and forming a heat reflective surface.

10. A skewered-food cooker according to claim 9 wherein the front panel substantially overlies the planar arrangement of the plurality of skewers and can be opened to access the plurality of skewers.

11. A skewered-food cooker according to claim 10 wherein the front panel is formed of a transparent material to allow ready viewing of the plurality of skewers in a planar arrangement.

12. A skewered-food cooker according to claim 10 wherein the front panel is heat reflective so as to reflect heat back towards the food on the skewers.

13. A skewered-food cooker according to claim 9 wherein the front panel of the skewered-food cooker is mounted in a hinged manner relative to the planar arrangement of the skewer cooking elements such that the front panel of the skewered-food cooker can be moved from a position extending in a narrowly spaced planar arrangement to the planar arrangement of the array of cooking elements or be moved to an open position allowing access to food on the skewers mounted in the planar arrangement.

14. A skewered-food cooker according to claim 1 wherein each skewer includes a flat finger holding plate at one end of the skewer shaft to facilitate handling and to provide an advertising location.

15. A skewered-food cooker according to claim 14 wherein each skewer holder includes a mounting element having a trumpet opening for receiving the end of a skewer and directing it to a central opening having a circumferential frictional gripping element.

16. A skewered-food cooker according to claim 15 wherein the gripping element is a silicon ring.

17. A skewered-food cooker according to claim 15 wherein the skewer holder includes a detachment means allowing ready access from the rear of the trumpet and replacement of the circumferential frictional gripping element.

18. A cooking system comprising;
a. receiving and holding a plurality of skewers holding uncooked food in a skewered arrangement wherein the plurality of skewers are substantially vertically aligned;
b. providing cooking elements in a relative adjacent planar arrangement for cooking the plurality of skewers in the substantially vertically aligned arrangement; and
c. providing an overflow receptacle below the substantially vertically aligned arrangement of skewers;
whereby the plurality of skewers in substantially vertically aligned arrangement provide cooking of the food and dripping of expelled cooking juices to a lower skewer and to the overflow receptacle.

19. A cooking system according to claim 18 wherein the arrangement allows for ready viewing of the substantially vertically aligned arrangement of skewers of food while cooking and can be opened to access the plurality of skewers.

20. A cooking system according to claim 18 wherein the arrangement allows for a front panel which is at least partially heat reflective so as to reflect heat back towards the food on the substantially vertically aligned arrangement of skewers of food while cooking.

21. A cooking system according to claim 18 wherein the plurality of skewers are received and held in a linear array of skewer holders which is hingedly mounted relative to the array of cooking elements whereby the plurality of skewers received therein with food thereon can be moved from a position extending in a narrowly spaced planar arrangement to the planar arrangement of the array of cooking elements or be moved to a non cooking further spaced position.

22. A cooking system according to claim 18 including an after cooking sauce flavouring system which allows a single cooking process to provide a plurality of different final products as if cooked in different manners.

23. A cooking system comprising:
receiving and holding a plurality of skewers holding uncooked food in a skewered arrangement wherein the plurality of skewers are substantially vertically aligned;
providing a skewered-food cooker for cooking the plurality of skewers in the substantially vertically aligned arrangement;
providing a transparent front panel which substantially overlies the planar arrangement of the plurality of skewers; and
providing an overflow receptacle below the substantially vertically aligned arrangement of skewers; whereby the plurality of skewers in substantially vertically aligned arrangement provide cooking of the food and dripping of expelled cooking juices to a lower skewer and to the overflow receptacle.

24.-25. (canceled)
